(19) United States
(12) Patent Application Publication
(10) Pub. No.: US 2006/0013394 A1
(43) Pub. Date: Jan. 19, 2006

(54) ATM data transmission systems

(76) Inventor: Robin E. O'Brien, Ringwood (GB)

Correspondence Address: NIXON & VANDERHYE, PC, 901 NORTH GLEBE ROAD, 11TH FLOOR, ARLINGTON, VA, 22203, US

(21) Appl. No.: 10/052,107

(22) Filed: Jan. 17, 2002

(30) Foreign Application Priority Data
Jan. 23, 2001 (GB) 0101704.5

(51) Int. Cl. H04K 1/00

(52) U.S. Cl. 380/255; 380/287; 380/59

(57) ABSTRACT

A method of hardening ATM cells (10), the ATM cells (10) each including a header (12) and payload (11), the method including the steps of hardening individual ATM cells by encoding the header and payload and encapsulating the resulting data (20, 21) from each cell within a transmission frame dedicated to that cell.

### FIELD OF THE INVENTION

This invention relates to improvements in Asynchronous Transfer Mode (ATM) data transmission systems. More particularly, although not exclusively, this invention relates to techniques and apparatus for hardening ATM data packets (cells) for transmission in environments which produce intrinsically high error rates.

### BACKGROUND TO THE INVENTION

Asynchronous Transfer Mode (ATM) is a packet oriented system for transferring digital information based on the use of ATM cells. ATM data is transmitted as a contiguous stream of ATM cells where each cell has a constant length and comprises a header label of 5 bytes and a payload field of 48 bytes (see FIGS. 1a and 1b).

The system is asynchronous in that the cells are identified by means of address information carried in the header label and not by their position in relation to a fixed time reference.

Referring to FIG. 1b, the header label includes an address field which includes the virtual path identifier (VPI) and the virtual channel identifier (VCI). The header label also includes, amongst other things, an 8 bit CRC field for header error control.

The relatively small and constant size of an ATM cell allows ATM hardware to transmit video, audio and data over the same network with rudimentary cell prioritisation being handled by appropriate fields in the header.

A significant problem in many data transmission networks, including ATM systems, is data loss/corruption. This may be in the form of cell loss or bit-level loss/corruption and can be the result of traffic congestion or external error/interference effects which are not dependent on traffic load. The present invention is primarily concerned with techniques by which resistance to cell corruption, regardless of the source of corruption, can be enhanced. This is referred to as “cell hardening” in the present application. In the case of ATM cells, the content of the header renders the cell as a whole particularly vulnerable to corruption or loss. If the header is damaged, the ATM cell cannot be delivered at all as all addressing information is in the header.

The following discussion will be given in the context of tactical networks, specifically those found in military environments. However, this is not to be construed as a limiting application. The invention may be applied in any environment where increased or enhanced cell transmission reliability and resistance to corruption is required. Other examples include satellite transmission links and error-prone links carrying different types of traffic such as voice, video and data.

For a tactical network to be effective, some form of error protection must be implemented to avoid unacceptable loss of traffic on high error rate links. High error rates may be the result of the intrinsic nature of the battlefield environment, natural causes or manmade interference such as jamming.

Commercial ATM networks usually require link integrities of better that 1 in 10⁷ while tactical links are envisaged to operate in error environments of up to 1 in 10³. There have been a number of attempts to provide improved ATM error correction/handling in error prone transmission environments. A disclosure which to a certain extent does address ATM cell integrity is U.S. Pat. No. 5,600,653 (to Chitre et al). This document describes a general technique for manipulating an ATM cell's contents in order to enhance error protection. In particular, this document describes interleaving data between a plurality of ATM cells. This spreads the effect of any link errors through the bitstream and thus does not focus the corruption on a single ATM cell. This document does not address in-cell hardening at any sort of detailed level.

Accordingly, the aim of the present invention is to provide a method and apparatus which provides improved ATM cell protection in error-prone environments.

### DISCLOSURE OF THE INVENTION

In one aspect, the invention provides for a method of hardening ATM cells, the ATM cells each including a header and payload, the method including the steps of hardening individual ATM cells by encoding the header and payload and encapsulating the resulting data from each cell within a transmission frame dedicated to that cell.

The header and payload may be interleaved within an individual transmission frame.

The error correction may be applied separately to the header and the payload prior to framing them in a transmission frame.

In an alternative embodiment, the header and/or payload may be randomly interleaved into the transmission frame.

In a preferred embodiment of the invention, the encoding step corresponds to Reed Solomon forward error correction.

The Reed Solomon forward error correction may be applied to the header and payload separately following which the encoded header is interleaved with the encoded payload.

The bits used for framing the encoded ATM cell may be derived from empty or idle ATM cells in the datastream.

Preferably elimination/use of empty/idle ATM cells is performed in such a way that input and output data rates of an ATM link are substantially matched.

### BRIEF DESCRIPTION OF THE DRAWINGS

The invention will now be described by way of example only and with reference to the figures in which:

FIG. 1: illustrates a prior art ATM cell structure;

FIG. 2: illustrates framing and interleaving applied to an individual ATM cell;

FIG. 3: illustrates a simplified schematic of the architecture of an ATM cell hardening device/unit;

FIG. 4: illustrates a schematic of a simplified portion of an ATM network showing the location of a cell hardening unit/device; and

FIG. 5: illustrates a simplified block schematic for a prototype cell hardening device/unit (CHU).

The following discussion will generally relate to ATM data transmission in error-prone military environments. The cell hardening system described herein is, in one embodiment, intended for protecting ATM trunks being carried over, for example, a radio relay link that is subject to a tactical environment. Other applications are envisaged, such as protecting satellite links.

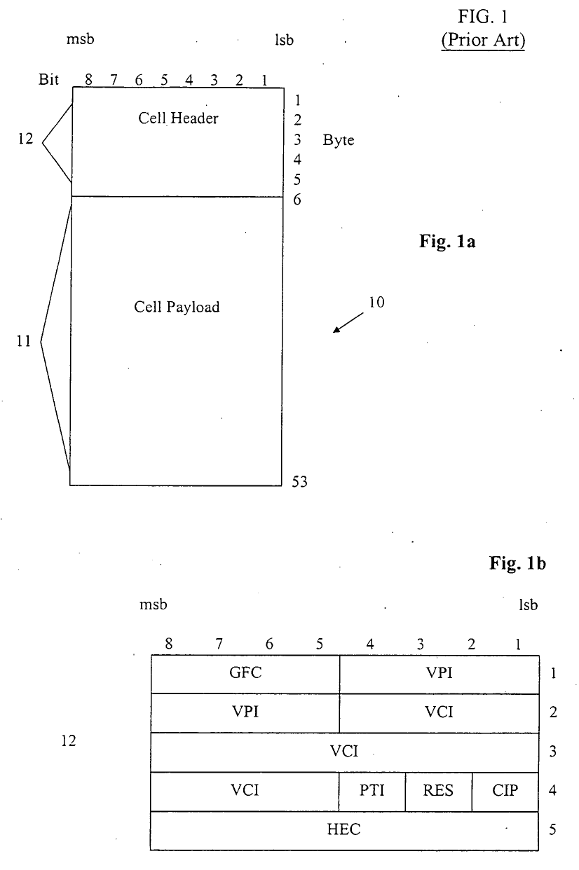

FIG. 1 illustrates a schematic of a prior art ATM data packet. ATM packet 10 (hereafter referred to as a cell) consists of a payload field 11 and header 12. The payload 11 is 48 bytes and may correspond to network user information such as data, voice, images etc. The payload 11 can also carry overhead or operations and maintenance information. The header 12, shown in detail in FIG. 1b, includes: an address field, including a VPI: virtual path identifier and VCI: virtual channel identifier, which defines the virtual channel to which the cell is assigned; payload type identifier: PTI; and an 8-bit CRC field for header error control (HEC), this latter field also provides the mechanism for cell structure delineation.

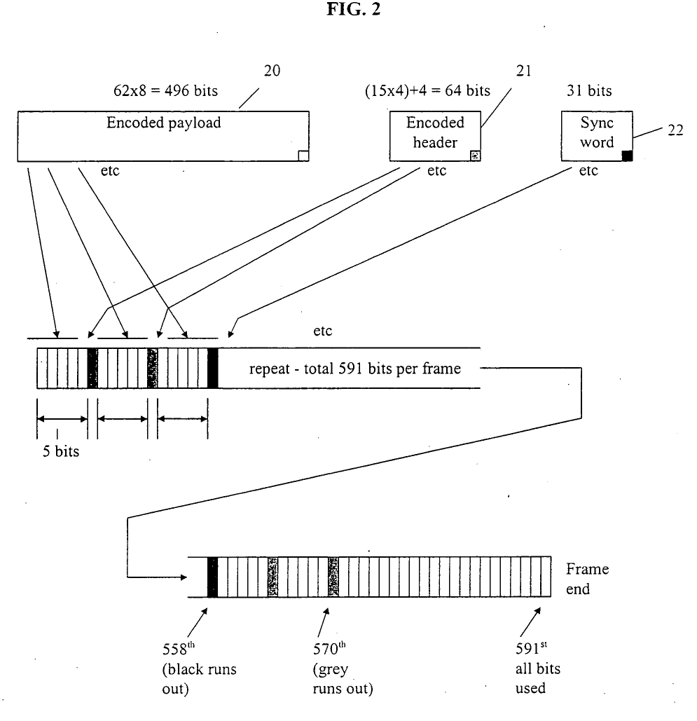

FIG. 2 illustrates a simplified schematic of the cell hardening technique according to one aspect of the invention.

Individual ATM cells are encapsulated within an error correction codeword. Specifically, two complete Reed Solomon codewords applied to the header (21) and payload (20) as will be discussed below. As individual ATM cells are hardened, if the error correction is overloaded, only a single cell is compromised and error multiplication will be avoided.

Within an ATM cell, the header bytes are particularly sensitive in that if they are corrupted, this will cause total loss of the cell as all addressing information can be lost regardless of the integrity of the rest of the ATM cells contents. Using knowledge of the header position in conjunction with header encoding, an additional level of protection is provided for. In addition, the header check byte may be replaced by stronger code to achieve additional protection and to identify uncorrectable headers.

Additional bits are used in hardening each ATM cell. These extra bits are used to provide extra encoding for the payload and the header. They may be derived from idle or unassigned ATM cells, if available, otherwise they contribute to link overheads.

Returning to the structure of the hardened ATM cell, in accordance with the invention, FIG. 2 shows the encoded payload 20, encoded header 21 and (where implemented) a 31 bit synchronisation word 32, interleaved into a contiguous bit stream forming a frame 591 bits in length. Each cell therefore contains two complete Reed Solomon codewords which maximises protection against errors for the shorter, non-payload elements. To this end, the sensitivity of the payload data to burst errors may vary depending on the nature of the ATM network user traffic (i.e. voice, data etc.). The hardened ATM cells are then transmitted via the network as described above.

Reed Solomon forward error correction is used as the basic element of the design architecture. This form of encoding was chosen as it provides a good mix of bit error and burst error correction and is relatively straightforward to implement. Specific implementations of Reed-Solomon encoding are considered within the purview of the skilled person and will not be discussed in detail herein.

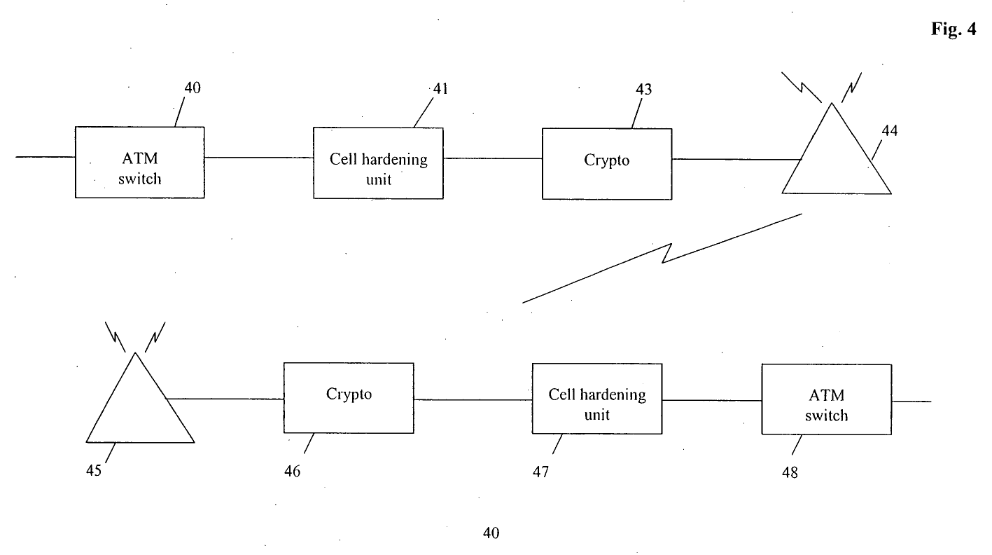

FIG. 4 shows the general layout of a simplified portion of an ATM network illustrating the location of the cell hardening devices of the present invention.

The general operation of such an ATM network is as follows. A standard ATM switch 40 receives ATM cells from a network (not shown). These are passed to a Cell Hardening Unit (CHU) 41 which processes the cell according to the invention and as described above. The hardened cells may be subject to cryptographic processes and then transmitted via, for example, an RF link 44/45. The hardened cells are decrypted if necessary (46) and decoded (47) as described below. The unpacked cells are then passed to an ATM switch (48) for transmission via the network.

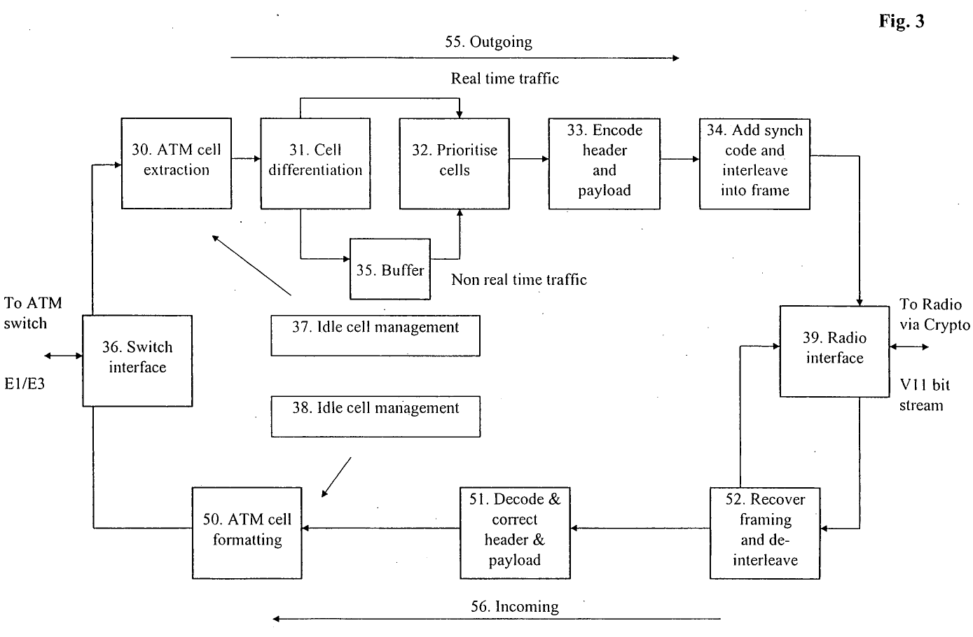

FIG. 3 illustrates a schematic of an illustrative cell hardening device (for example, 41 and 47 in FIG. 4) architecture. The outgoing path (55) shown in FIG. 3 accepts traffic cells from an ATM switch (not shown). The frame payload is cell delineated (30) while discarding idle and unassigned cells (37). The VPI value of the cell header is then checked (31,32) to identify the cell as one of the two supported types. For example if the VPI is odd, then the cell contains voice information and will be given a high priority. If the VPI is even, the cell contains data information and will follow a lower priority route through the CHU.

The cell is then stored in the data or voice buffer (35) as appropriate. If the buffers are full, then the cell is discarded. Cells are removed from the buffer when the transmitter is able to take them.

By way of rudimentary cell prioritisation, cells in the data buffer are only processed when the voice buffer is empty. Similarly, when both buffers are empty, idle cells are generated and transmitted to maintain the physical link rate of the data connection.

Data cells are not transmitted when the radio interface receiver is out of synchronisation. However voice and idle cells continue to be transmitted when the radio interface is reporting out of synchronisation.

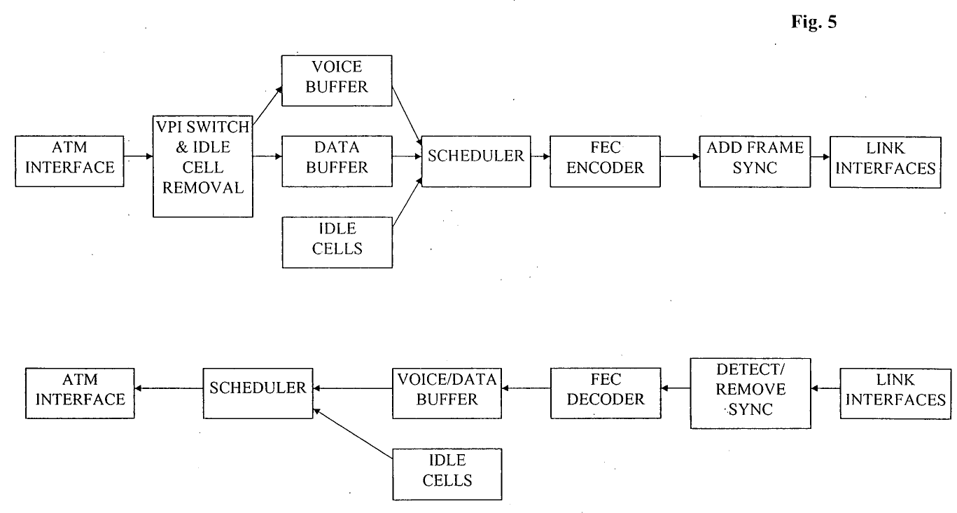

According to the operation of a prototype CHU, the cell is then converted into a packed cell by inserting 3 dummy bytes between the cell header and the cell payload. This is shown in the block schematic illustrated in FIG. 5. However, in the preferred form of the invention, and that discussed in detail herein, the three dummy bytes correspond to reserved areas for implementing, amongst other things, header protection etc.

The 56 byte packed cell is then passed to the Reed Solomon encoder (33) for forward error correction encoding. After a processing delay, the FEC packed and interleaved (34) cell is read from the Reed Solomon encoder and serially clocked out of the CHU at a selectable rate. The series of frames (hardened ATM cells) then leaves the device as a contiguous bit stream which is then sent for transmission on, in the present case, a radio link (39).

The incoming path (56) shown in FIG. 3 accepts a bit stream of hardened ATM cells from a radio link (39). The frame delineated cells are converted back into forward error corrected packed cells (52) and passed to the Reed Solomon decoder (51). If the output of the Reed Solomon decoded bitstream contains less than one complete cell, an idle cell is inserted (38). This ensures that a continuous stream of cells is emitted from the CHU interface. The reconstructed ATM cells (50) are then passed to the ATM switch via interface (36).

In trials, the ATM cell hardening method according to the present invention has been found to yield traffic reliability with link error rates below 1 in 10³. The advantages and viability of the present approach to network traffic protection have thus been amply demonstrated. Unlike previous attempts to enhance the resistance of ATM cells to corruption, the present invention ensures that the cell payload is delivered even when the cell is damaged. Delivering a cell correctly, but with a partially corrupted payload, may be worthwhile in situations where a significant residual error rate can be tolerated. Such an example is in voice communications where the human ear can, to a certain extent, interpolate between breaks and corrupted portions of audio material.

Thus by the invention described herein and the embodiments referred to above, the present invention provides for an ATM cell handling and transmission technique and apparatus which have resulted in link error rates below 1 in 10³.

Although the present invention has been described by way of example only and with reference to the possible embodiments thereof, it to be appreciated that improvements and/or modifications may be made thereto without departing from the scope of the invention as set out in the appended claims.

Where in the foregoing description reference has been made to integers or components having known equivalents, then such equivalents are herein incorporated as if individually set forth.

1-3. (canceled)

4. A method of hardening ATM cells, the ATM cells each including a header and payload, the method including the steps of encoding the header and payload within an individual transmission frame, wherein the header and payload are interleaved within an individual transmission frame, wherein error correction is applied separately to the header and the payload prior to interleaving them within a transmission frame, wherein the error correction corresponds to Reed Solomon forward error correction.

5. A method as claimed in claim 4 wherein the Reed Solomon encoding is applied to the header and payload separately following which the encoded header is interleaved with the encoded payload.

6. A method as claimed in claim 4 where empty/idle ATM cells are eliminated/used to substantially match input and output rates of an ATM link.

7. (canceled)

8. An apparatus adapted for hardening ATM cells in accordance with the method of claim 4.

9. (canceled)
